(19) United States
(12) Patent Application Publication
(10) Pub. No.: US 2015/0073578 A1
(43) Pub. Date: Mar. 12, 2015

(54) System and method for converting a three dimensional model to a non-application specific format

(71) Applicant: Caterpillar Inc., Peoria, IL (US)

(72) Inventors: Saravanan V. Anthipagulu, Chennai (IN); Babu M. Kondai, Chennai (IN); Anuop Udayakumar, Chennai (IN); Suresh Padmasale, Chennai (IN); Murugadoss Balasubramanian, Chennai (IN)

(73) Assignee: Caterpillar Inc., Peoria, IL (US)

(21) Appl. No.: 14/543,894

(22) Filed: Nov. 18, 2014

(51) Int. Cl. G05B 19/4097; G06F 17/50

(52) U.S. Cl. CPC G05B 19/4097; G06F 17/50; G05B 2219/35005
USPC 700/98

(57) ABSTRACT

A computer-implemented method for converting a three dimensional model to a non-application specific format that is used for sheet metal manufacturing is provided. The method includes receiving a user input, via a Graphical User Interface (GUI), to select the non-application specific format from a defined group of non-application specific formats. The method also includes receiving a user input, via the GUI, to select the three dimensional model that has multiple surfaces from a database, receiving a user input, via the GUI, to select a surface and receiving a user input, via the GUI, to select a feature that is unrelated to the sheet metal manufacturing. The method includes removing the feature to create a two dimensional model of the selected surface, converting the two dimensional model to the selected non-application specific format and creating a file corresponding to the two dimensional model in the selected non-application specific format.

### TECHNICAL FIELD

The present disclosure generally relates to a system and method for converting a three dimensional model into other formats. More particularly, the present disclosure relates to a method of converting a three dimensional model into a non-application specific format.

### BACKGROUND

Typically, sheet metal manufacturing includes using a Computer Numeric Control (CNC) laser machine to cut planar components. The planar components may then be bent and/or machined as per requirements to obtain the final product. The CNC laser may cut multiple such planar components from a single metal sheet. The various planar parts are nested in order to minimize scrap. A nesting software may require files of the individual planar components in IGES/DXF file format for performing nesting function.

Conventional methods for conversion of a three dimensional model of the component to the IGES/DXF file format may require performing multiple manual steps. Performing such manual steps may increase time required for conversion of the three dimensional model. Moreover, these methods may increase a possibility of occurrence of errors which may result in a defective final product.

For reference, U.S. Pat. No. 6,779,175 is related to a method of converting a program, such as a graphic database, representing the geometry of a workpiece, into numeric control code in order to program a numeric machine control to operate a machine, such as a router. The machine control receives and processes the program according to a set of machine-specific attributes, including axis configuration and worktable size and layout. Operational attributes, such as feed rate and tool assignments, are specified. Optionally, multiple components or workpieces are nested into a cluster, and available off-fall sheets are matched to the cluster, so as to maximize the efficient use of material. Numeric code is then generated to permit the machine control to operate the machine.

### SUMMARY OF THE DISCLOSURE

One aspect of the present disclosure relates to a computer-implemented method for converting a three dimensional model to a non-application specific format. The selected non-application specific format is used for sheet metal manufacturing. The method includes receiving a user input, via a Graphical User Interface (GUI), to select the non-application specific format from a defined group of non-application specific formats. The method also includes receiving a user input, via the GUI, to select the three dimensional model that has multiple surfaces from a database. The method further includes receiving a user input, via the GUI, to select a surface from the multiple surfaces. The method also includes receiving a user input, via the GUI, to select a feature that is unrelated to sheet metal manufacturing from the selected surface. The method includes removing the feature to create a two dimensional model of the selected surface. The method further includes converting the two dimensional model to the selected non-application specific format. The method includes creating a file corresponding to the two dimensional model in the selected non-application specific format.

Other features and aspects of this disclosure will be apparent from the following description and the accompanying drawings.

### BRIEF DESCRIPTION OF THE DRAWINGS

FIG. 1 is a block diagram of a system for converting a three dimensional model of a part to a non-application specific format, according to an embodiment of the present disclosure;

FIG. 2 illustrates a Graphical User Interface (GUI) of the system displaying the three dimensional model, according to an embodiment of the present disclosure;

FIG. 3 illustrates the GUI displaying a top view of a selected surface of the three dimensional model;

FIG. 4 illustrates the GUI displaying a selection of features of the three dimensional model to be removed;

FIG. 5 illustrates the GUI displaying the three dimensional model of the part with the selected features being removed;

FIG. 6 illustrates the GUI displaying a two dimensional model of the part in the non-application specific format; and

FIG. 7 illustrates a flowchart of a method of converting a three dimensional model to a non-application specific format, according to an embodiment of the present disclosure.

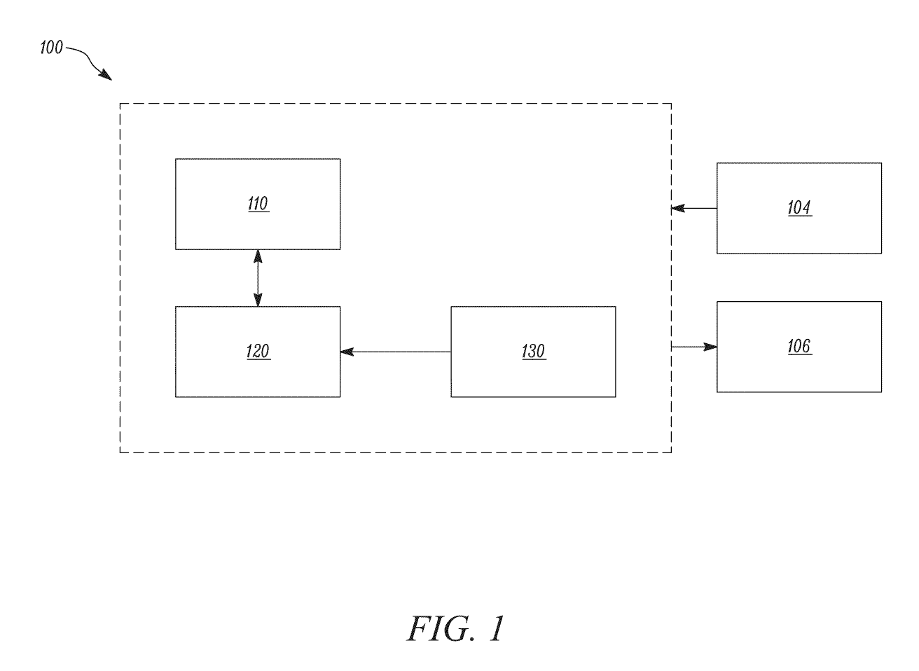

### DETAILED DESCRIPTION

Wherever possible, the same reference numbers will be used throughout the drawings to refer to same or like parts. FIG. 1 illustrates a block diagram of a system 100, according to an embodiment of the present disclosure. The system 100 is employed to convert a three dimensional model of a part to a non-application specific format. In an example, the three dimensional model may be a CAD model, a CAM model, and the like. Moreover, a file in the non-application specific format may be compatible with multiple environments. The non-application specific formats may be, for example, a DXF format, an IGES format or any other formats known in the art.

The system 100 is disposed in communication with a 3D software 104 and a nesting software 106. The 3D software 104 is a computer implemented product that is configured to generate a three dimensional model of a part. In an embodiment, the system 100 is integrated with the 3D software 104, such as, Pro/Engineer, Catia, Unigraphics etc. The nesting software 106 may receive files of various parts in the non-application specific formats from the system 100. The nesting software 106 is configured to perform a nesting arrangement of the parts. Further, one or more manufacturing operations such as, a metal cutting process may be performed on sheet metals in accordance with the nesting arrangement to obtain a flat pattern of a finished product.

The system 100 includes a Graphical User Interface (GUI) 110, a computing module 120 and a database 130. The GUI 110 may include a touch based interface, a keyboard based interface, a pointing device (e.g., a mouse) based interface, or a combination thereof. The computing module 120 is in communication with the GUI 110 and the database 130. The computing module 120 may receive one or more user inputs via the GUI 110. The computing module 120 may be any microprocessor based system, for example, a computer. The computing module 120 is configured to execute instructions and provide one or more outputs based on the user inputs. The database 130 may include data stored in an inbuilt memory associated with the computing module 120. Alternatively, the database 130 may include data stored in a memory external to the computing module 120. The computing module 120 is configured to access data from the database 130. The database 130 may receive one or more three dimensional models from the 3D software 104. The three dimensional models may be stored in the memory. The database 130 may also be configured to receive output files from the computing module 120 that may be subsequently stored in the memory.

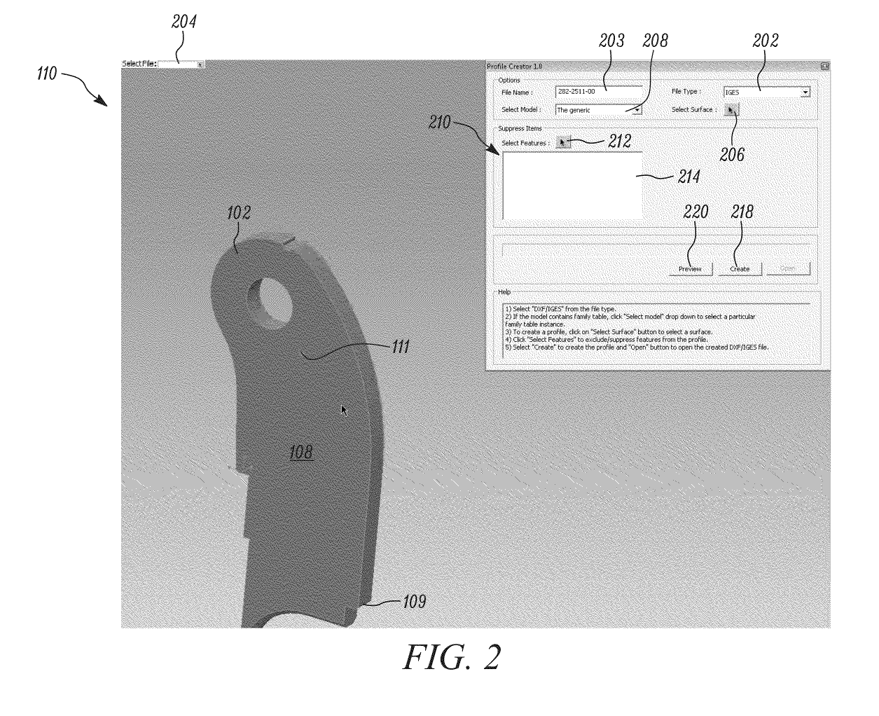

Referring to FIG. 2, the GUI 110 may include multiple graphical control elements. Each of the graphical control elements may allow a user to provide inputs related to various functions such as, but not limited to, selection of one or more features, creation of one or more files, and the like. The computing module 120 may be configured to receive the user inputs via one or more of these graphical control elements and perform further tasks. More specifically, the system 100 enables conversion of a three dimensional model into a selected non-application specific format based on user inputs via the GUI 110. In the illustrated embodiment, an exemplary three dimensional model 102 is shown.

The GUI 110 includes a first control element 202 that allows a user to select a non-application specific format from a defined group of formats. For example, the defined group of formats may include a DXF file format and an IGES file format. In the illustrated embodiment, the first control element 202 is an input box having a drop-down menu. The drop-down menu includes the defined group of formats. The first control element 202 allows a user to click on the drop down menu upon which a list of the formats from the group are displayed. The first control element 202 further allows the user to select one of the formats from the list.

In another embodiment, the first control element 202 may be a list box that provides the formats in the form of multiple lines. The first control element 202 may allow a user to select a format from the group of formats that are provided in the multiple lines.

The computing module 120 is configured to receive an instruction to select a format based on the user input via the first control element 202. For example, if the user selects the DXF format from the list, the computing module 120 receives an instruction to select the DXF format. As such, the computing module 120, as will be discussed herein, subsequently creates a file in the DXF format.

The GUI 110 also includes an input box 203 that allows the user to input a name for the output file. The computing module 120 is configured to receive the name of the output file via the input box 203.

The GUI 110 also includes a second control element 204 that allows the user to select the three dimensional model 102 from the database 130. The second control element 204 may include a select button such as, a browse button. The second control element 204 may allow the user to click on the button upon which a folder including the set of three dimensional models may be opened. The GUI 110 may further allow the user to click on the three dimensional model 102 from the set of three dimensional models. The computing module 120 is configured to receive the user input corresponding to selection of the three dimensional model 102 via the second control element 204. The computing module 120 is further configured to retrieve the selected three dimensional model 102 from the database 130 and subsequently display the selected three dimensional model 102 on the GUI 110. The three dimensional model 102 includes multiple surfaces (one surface 108 shown in FIG. 2).

The GUI 110 may also include a control element 208 that allows the user to provide an input to select a type of the part. The control element 208 may be a drop-down menu that includes multiple menu items corresponding to various part types. In the illustrated embodiment, the menu includes two items corresponding to the part being a flat part and a bent part respectively. For example, if the selected three dimensional model 102 corresponds to the bent part, the user may select a menu item corresponding to the bent part. Further, the computing module 120 may be configured to change a file instance to an equivalent flat pattern of the bent part upon receiving the user input via the control element 208. In such a case, the computing module 120 is configured to display the flat pattern of the bent part on the GUI 110 and use the flat pattern for further processing. Moreover, upon receiving the user input via the control element 208, the computing module 120 may display the three dimensional model 102 in a suitable orientation.

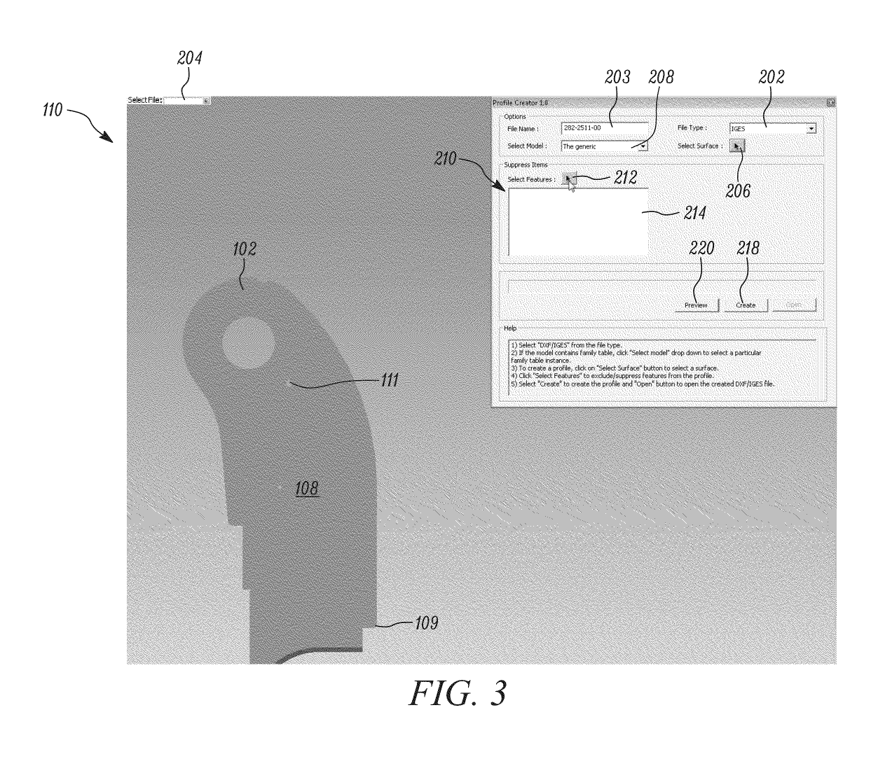

Referring to FIG. 3, the GUI 110 includes a third control element 206 that allows the user to select one of the surfaces from the multiple surfaces of the selected three dimensional model 102. In the illustrated embodiment, the surface 108 is selected. The third control element 206 is a select button that allows the user to click on the select button. Subsequently, the GUI 110 allows the user to click on the surface 108 that is to be selected. Moreover, the computing module 120 is configured to receive the user input corresponding to the selection of the surface 108 via the third control element 206.

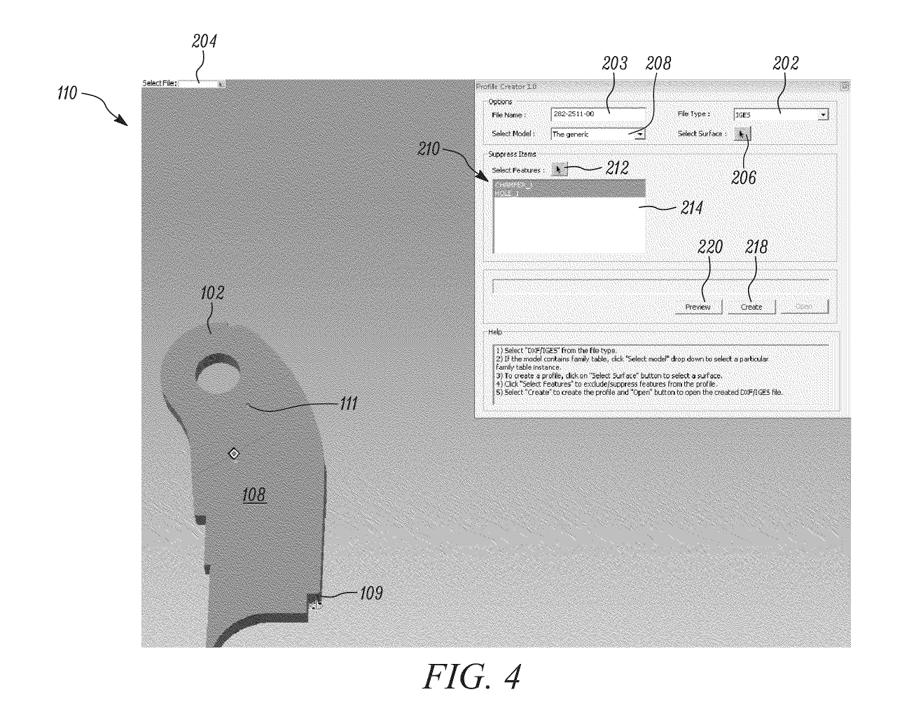

Referring to FIG. 4, the GUI 110 further includes a fourth control element 210 that allows the user to select one or more features of the selected three dimensional model 102. The selected three dimensional model 102 may include one or more features such as, a chamfer 109, a hole 111, and the like. Such features may be unrelated to the sheet metal cutting operations. The fourth control element 210 allows the user to select these unrelated features. The fourth control element 210 includes a select button 212 and a dialogue box 214. The fourth control element 210 allows the user to click the select button 212 and the GUI 110 subsequently allows the user to click on one or more unrelated features from the selected three dimensional model 102. Moreover, as the user clicks on a particular feature from the three dimensional model 102, a name of the feature may be displayed in the dialogue box 214. Additionally, the dialogue box 214 may allow the user to deselect one or more features displayed thereon.

In various other embodiments, the fourth control element 210 may be a drop down menu or a list box which includes a list of all the features of the selected three dimensional model 102. The fourth control element 210 may allow the user to conditionally select one or more features to be removed from the list of all the features. In the illustrated embodiment, a user selects the chamfer 109 and the hole 111 defined in the selected three dimensional model 102. The computing module 120 is configured to receive the user input via the fourth control element 210 corresponding to selection of the features 109, 111.

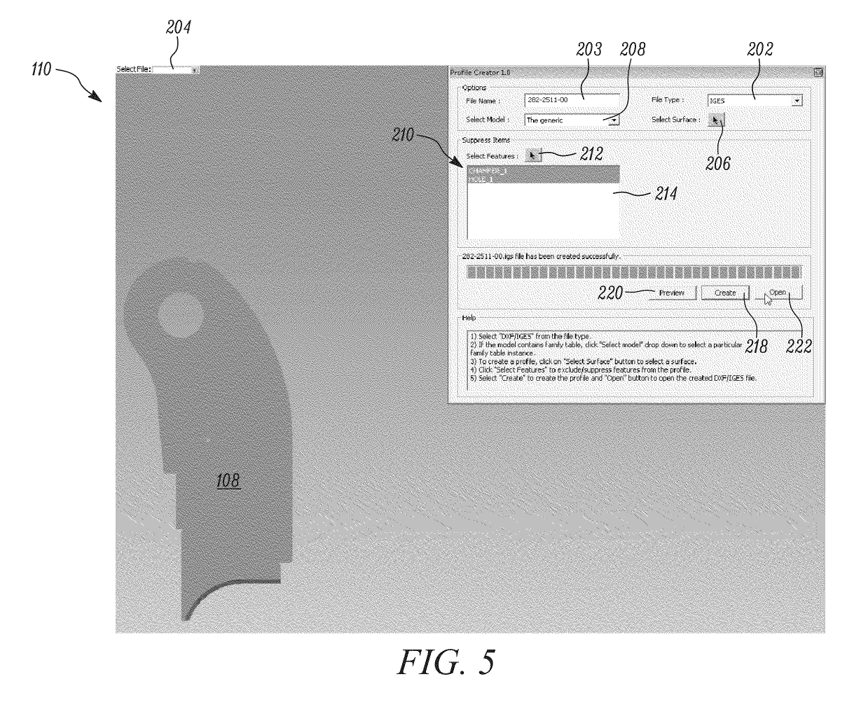

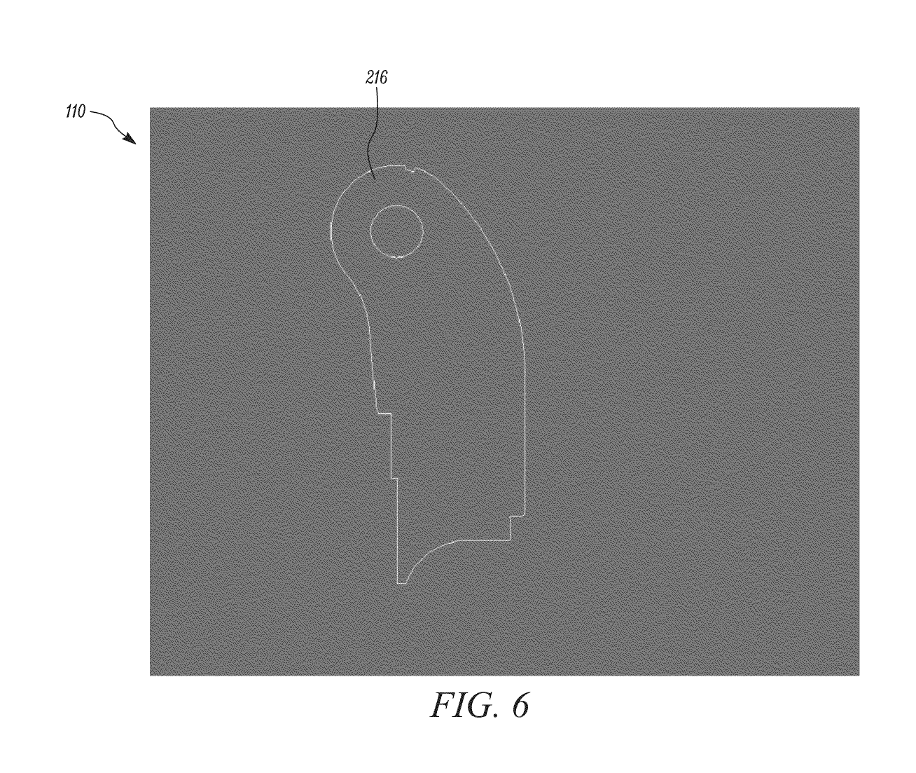

Referring to FIGS. 5 and 6, the computing module 120 is configured to remove the selected features and create a two dimensional model 216 (shown in FIG. 6) of the selected surface 108. The GUI 110 includes a sixth control element 220 that allows the user to provide an input to preview the two dimensional model 216. The sixth control element 220 may be a select button. The computing module 120 is configured to receive the user input, via the sixth control element 220, corresponding to generation of the preview of the two dimensional model 216. The computing module 120 accordingly generates the preview for display to the user on the GUI 110.

The GUI 110 further includes a fifth control element 218. The fifth control element 218 allows the user to provide an input to create the two dimensional model 216 of the selected surface 108. The fifth control element 218 may be a select button. Moreover, clicking of the button may open a dialogue box (not shown) showing a message. Further, the dialogue box may include a confirmation button (not shown). The GUI 110 may allow the user to click on the confirmation button so as to create the two dimensional model 216 in the selected non-application specific format. The computing module 102 is configured to receive the input via the fifth control element 218 and create the two dimensional model 216. The computing module 102 is also configured to convert the two dimensional model 216 to the selected non-application specific format. The computing module 120 is further configured to create the file corresponding to the two dimensional model 216 in the selected non-application specific format.

Further, the computing module 120 creates a file of the two dimensional model 216 in the selected non-application specific format. Moreover, the computing module 120 may store the file in the memory of the database 130 by the file name provided by the user via the input box 203. The GUI 110 further includes a seventh control element 222 that allows the user to provide an input corresponding to opening of the created file. The seventh control element 222 may be a select button. The computing module 120 is configured to open the created file upon receiving the user input via the seventh control element 222. Moreover, the computing module 120 may be configured to display the two dimensional model 216 on the GUI 110 upon receiving the user input via the seventh control element 222.

A person of ordinary skill in the art will acknowledge that the GUI 110 and the corresponding graphical control elements explained above are merely exemplary in nature and hence non-limiting of this disclosure. Moreover, necessary design and/or functional modifications may be possible for the GUI 110 without deviating from the scope of the present disclosure.

The system 100 is disposed in communication with the nesting software 106. The nesting software 106 may receive the created file as input for further processing.

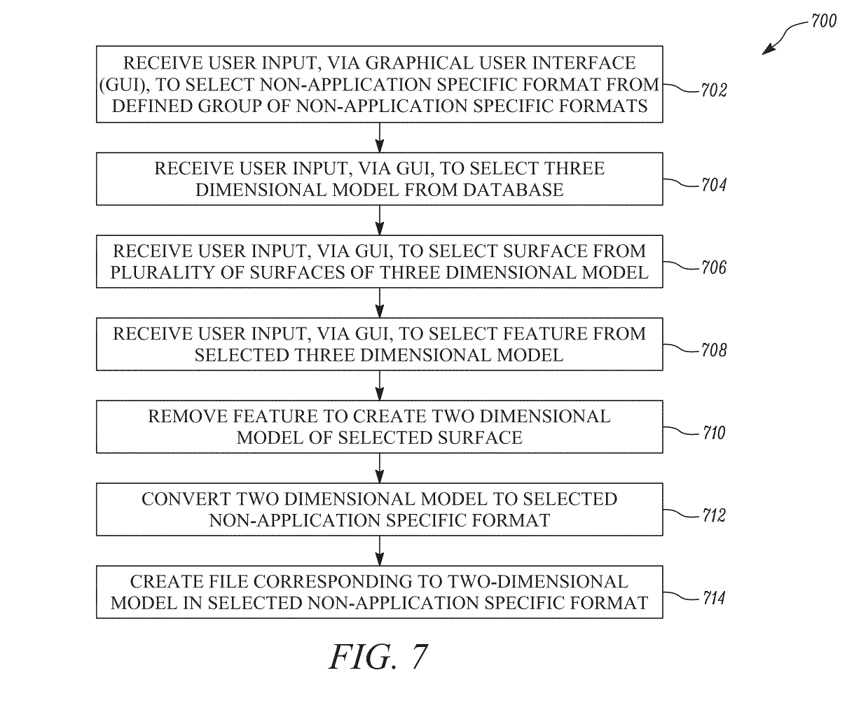

FIG. 7 illustrates a flowchart of a computer-implemented method 700 of converting the three dimensional model 102 to the non-application specific format, according to an embodiment of the preset disclosure. In an embodiment, the method 700 may be implemented via the system 100 described above.

At step 702, the method 700 includes receiving a user input via the GUI 110 to select the non-application specific format from a group of non-application specific formats. In the illustrated embodiment, the first control element 202 of the GUI 110 allows a user to provide an input corresponding to selection of the desired non-application specific format. Further, the computing module 120 is configured to receive the user input corresponding to selection of the non-application specific format via the first control element 202.

At step 704, the method 700 includes receiving a user input, via the GUI 110, to select the three dimensional model 102 from the database 130. In the illustrated embodiment, the second control element 204 of the GUI 110 allows the user to provide an input to select the three dimensional model 102. Further, the computing module 120 is configured to receive the user input corresponding to selection of the three dimensional model 102 via the second control element 204. At step 704, the method 700 may further include receiving a user input, via the GUI 110, that is indicative of a type of the part. In the illustrated embodiment, the control element 208 of the GUI 110 allows a user to provide an input to select a type of the part. Moreover, the computing module 120 is configured to change a file instance to the flat pattern upon receiving a user input corresponding to the part being the bent part. In such a case, the equivalent flat pattern may be used thereafter for further processing.

At step 706, the method 700 includes receiving a user input, via the GUI 110, to select a surface from the multiple surfaces of the three dimensional model 102. In the illustrated embodiment, the third control element 206 of the GUI 110 allows the user to provide an input to select the surface 108. Further, the computing module 120 is configured to receive the user input corresponding to selection of the surface 108 via the second control element 204.

At step 708, the method 700 includes receiving a user input, via the GUI 110, to select a feature from the selected surface that is unrelated to the sheet metal manufacturing. In the illustrated embodiment, the fourth control element 210 of the GUI 110 allows the user to provide an input to select one or more features such as, the chamfer 109 and the hole 111 that are unrelated to the sheet metal manufacturing. Moreover, the GUI 110 may allow the user to optionally provide an input to select the unrelated features. Further, the computing module 120 is configured to receive the user input corresponding to selection of the features 109, 111 via the third control element 206.

At step 710, the method 700 includes removing the features to create the two dimensional model of the selected surface. In the illustrated embodiment, the computing module 120 removes the hole 111 and the chamfer 109 that are selected via the third control element 206. Further, the computing module 120 is configured to create the two dimensional model 216 of the selected surface 108.

At step 712, the method 700 includes converting the two dimensional model 216 to the selected non-application specific format. The computing module 120 processes various inputs provided by the user and converts the two dimensional model 216 to the selected non-application specific format. The selected non-application specific format is based on the user input received via the first control element 202 in step 702.

At step 714, the method 700 includes creating the file corresponding to the two dimensional model 216 in the selected non-application specific format. The fifth control element 218 of the GUI 110 allows the user to provide an input to create the file. The computing module 120 receives the user input via the fifth control element 218 and subsequently creates the file. Moreover, the created file has a name that is provided by the user via the input box 203. The created file may be stored in the memory of the database 130. One or more of these files in the non-application specific format may be used by the nesting software 106 for performing the nesting function.

### INDUSTRIAL APPLICABILITY

The system 100 and method 700 of the present disclosure has applicability for use and implementation in converting a three dimensional model to a non-application specific format. An implementation of the method 700, as disclosed herein, may require minimum manual intervention thereby reducing a possibility of occurrence of error.

Additionally, a user may be able to quickly convert the three dimensional model to any desired non-application specific format by implementation of the method 700, thereby saving time. Moreover, one or more components of the system 100 may be integrated into an existing 3D software.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer-implemented method for converting a three dimensional model to a non-application specific format, the selected non-application specific format being used for sheet metal manufacturing, the method comprising:
receiving a user input, via a Graphical User Interface (GUI), to select the non-application specific format from a defined group of non-application specific formats;
receiving a user input, via the GUI, to select the three dimensional model from a database, the three dimensional model comprising a plurality of surfaces;
receiving a user input, via the GUI, to select a surface from the plurality of surfaces;
receiving a user input, via the GUI, to select a feature from the selected three dimensional model, wherein the feature is unrelated to sheet metal manufacturing;
removing the feature to create a two dimensional model of the selected surface;
converting the two dimensional model to the selected non-application specific format; and
creating a file corresponding to the two dimensional model in the selected non-application specific format.
